(19) United States
(12) Patent Application Publication
(10) Pub. No.: US 2006/0032728 A1
(43) Pub. Date: Feb. 16, 2006

(54) Apparatus for removing vehicle from vehicle assembly conveyor system

(76) Inventors: J. Rodney Smith, Kansas City, MO (US); Stephen R. Bode, Kansas City, MO (US); Donald R. Hollaway, Kansas City, MO (US)

Correspondence Address: Wm. Bruce Day;DAY LAW FIRM, P.C., 4330 Belleview, Suite 300, Kansas City, MO, 64111-3579, US

(21) Appl. No.: 10/914,814

(22) Filed: Aug. 10, 2004

(51) Int. Cl. B65G 37/00

(52) U.S. Cl. 198/468.6; 198/465.4

(57) ABSTRACT

An apparatus automatically lifts a vehicle from a continuously moving first convevor such as an overhead or a side lift vehicle assembly line conveyor carrier so that the vehicle can be stabilized for assembly processes or can be unloaded from the assembly line conveyor. The apparatus generally consists of a lift shuttle conveyed along guide rails positioned below the vehicle assembly conveyor system and with a lifting mechanism extending upwardly from the lift shuttle. The lifting mechanism rises to engage, stabilize and lift the vehicle from the overhead carrier. Various elevations can be obtained with the lifts to accommodate various processes and product requirements. After traveling along the lift shuttle conveyor, the vertical lifts lower the vehicle to either place the vehicle back on the overhead conveyor carrier or place the vehicle on a second conveyor or such as a floor conveyor where it is moved to further assembly operations or moved to a staging area. The shuttle then returns to its initial position to repeat the process for the next vehicle.

### BACKGROUND OF THE INVENTION

Vehicle unloading devices have long been used in automotive assembly plants and have been constructed in various designs. A common method for unloading vehicles from assembly line conveyors is accomplished by placing the vehicle from the assembly line conveyor directly on another conveyor while both conveyors continuously run. A common location for this transfer in assembly plants occurs after the vehicle tires have been installed. In a typical installation, the vehicle is carried on the assembly line conveyor carrier with the tires located lower than the carrier. The entire assembly line conveyor track lowers the carrier with the vehicle until the vehicle tires come into contact with a receiving conveyor, normally a flat top or slat conveyors. These flat top or slat conveyors support the vehicle with tires on a continuously conveyed surface. Once the vehicle becomes supported by the flat top conveyor, the carrier continues to lower and then opens to clear the vehicle. The carrier is then lifted up and away from the vehicle and the transfer is complete. The process provides the advantage of transferring from the assembly line conveyor without stopping the assembly conveyor. However, problems can occur when the tires on the vehicle are either flat or have low air pressure. When these occur, one or the other of the conveyors can contact the vehicle and cause damage. Other problems occur in synchronizing the receiving flat top or slat conveyor with the assembly conveyor. Damage to the vehicle is possible if the two conveyors are not synchronized.

Another type of unit, a high speed indexer, raises the vehicle from the conveyor carrier and transfers the vehicle forward at a higher speed than the speed of the conveyor carrier. After clearing the assembly line conveyor carrier the indexer lowers the vehicle or another conveyor, such as a flat top conveyor. A problem arises with indexer units because the high linear speeds necessary for indexer units requires large electrical or hydraulic drive systems. Typically, existing conveyor pits and conveyor systems cannot accept the larger components and conveyor pits have to be enlarged and reconstructed.

Yet other devices lift the vehicle from a conveyor carrier while the carrier is stopped. To maintain production line speed, stopping a conveyor carrier for unloading purposes requires a means to prevent the remaining upstream vehicles on the assembly line from stopping during the duration of the unloading process. Typically, this is done by transferring the conveyor carrier with the vehicle from a relatively slow assembly line speed to a higher speed to acquire the time to unload the vehicle and then once unloaded, speed back up to the assembly line speed. Unfortunately, this method requires a length of space along the assembly line for the transition to a higher speed.

### SUMMARY OF THE INVENTION

The present invention positively tracks a vehicle along an assembly line conveyor and removes and stabilizes the vehicle from the assembly line conveyor carrier in preparation for conducting further work on a vehicle which is necessarily stabilized. The invention is also used for transferring the vehicle to a flat top conveyor from the overhead or side mounted assembly line conveyor. The invention consists of a lift shuttle which rides along a floor conveyor and is stabilized by guide rails situated below the vehicle assembly conveyor system. The lift shuttle has a shuttle body with a lifting mechanism for engaging the vehicle and raising the vehicle from the vehicle carrier. The lift mechanism stabilizes the vehicle and, after a predetermined distance of travel of the lift shuttle on the guide rails, the lifting mechanism lowers the vehicle to either place the vehicle upon the vehicle carrier or place the vehicle on the floor conveyor system.

### OBJECTS OF THE INVENTION

The objects of the present invention are: to provide a means for stabilizing a vehicle that is being carried along a vehicle assembly line conveyor; to provide a means for removing a vehicle from an assembly line conveyor and transferring the vehicle to a second conveyor; to provide a device which transfers a vehicle from a vehicle assembly line overhead conveyor to a flat top conveyor; and to provide such a stabilizing and transfer mechanism that is particularly well adapted for the intended purpose. Other objects and advantages of the invention will become apparent from the following description.

### BRIEF DESCRIPTION OF THE DRAWINGS

FIG. 1 is a side elevational view of the stabilizing and transfer apparatus.

FIG. 2 is a front elevational view of the stabilizing and transfer apparatus.

FIG. 3 is a plan view of the shuttle conveyor.

FIG. 4 is a side elevational view of the lift shuttle.

FIG. 5 is a front elevational view of the lift shuttle.

### DETAILED DESCRIPTION OF THE PREFERRED AND ALTERNATIVE EMBODIMENTS

As required, an exemplary embodiment of the invention is disclosed herein. The following example discloses a preferred embodiment of the invention which may be embodied in various forms. The invention is not limited to the disclosed embodiment and is limited only insofar as set forth in the claims.

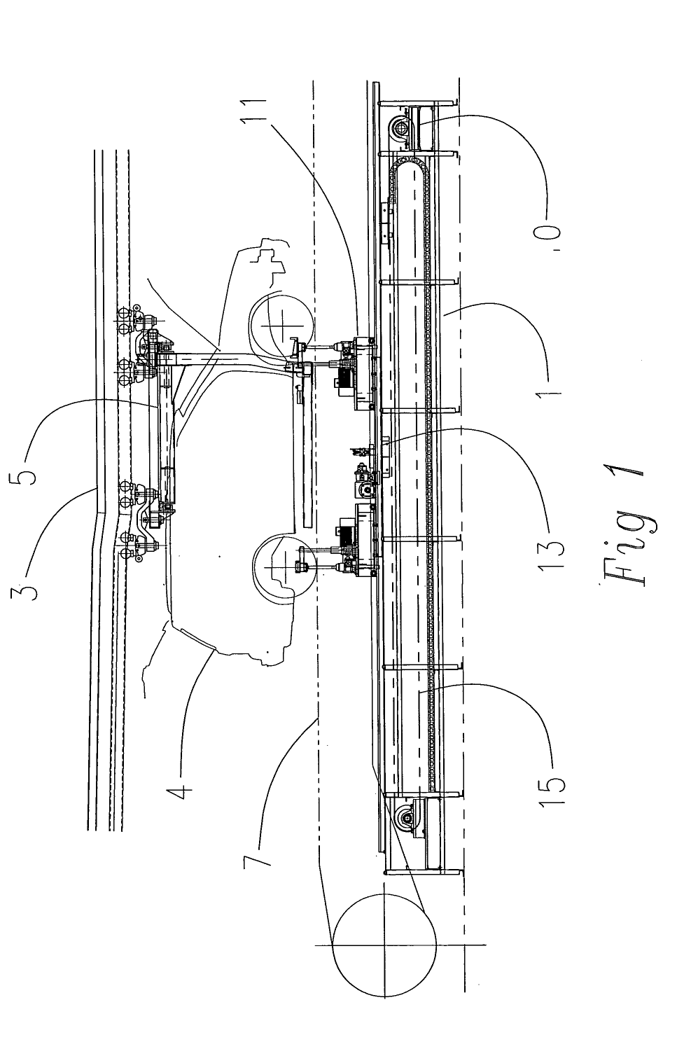

The reference numeral 1, FIG. 1, generally refers to a transfer and stabilizing apparatus for removing a vehicle. The apparatus 1 is used in conjunction with a first vehicle conveyor such as transport either a side mounted vehicle assembly line conveyor or with an overhead conveyor system. For purposes of illustration, an overhead conveyor system 3 is illustrated. The overhead conveyor system 3 carries partially completed vehicles 4 by carriers 5. Carriers 5 are controlled by the overhead conveyor system and can engage and disengage from the vehicle through control signals. The vehicles tend to sway and bounce as the overhead conveyor system travels so as a result for some assembly operations, the unsteady movement of the vehicles 4 on the conveyor system 3 can lead to assembly problems. The overhead conveyor system 3 is shown in FIG. 1 in conjunction with a second, receiving conveyor system, such as a flat top conveyor system 7. The transfer and stabilizing apparatus 1 transfers the vehicles 4 from the overhead conveyor system 3 to the flat top conveyor system 7.

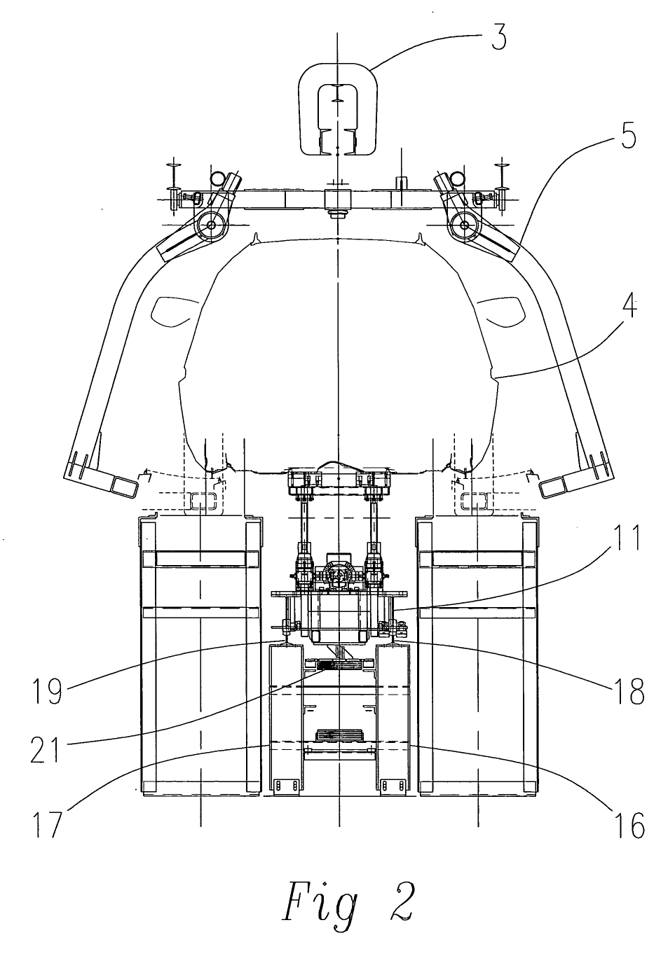

The transfer and stabilizing apparatus 1 generally consists of a shuttle conveyor 10 with a lift shuttle 11 which rides on the shuttle conveyor and lifts and stabilizes a selected vehicle 4. The lift shuttle 11 includes a lift body 13 of frame materials. The lift shuttle 11 has lifting means which are mounted on the lift body and operate to engage, stabilize and lift the vehicle from fixture connection points on the vehicle frame or unibody. As shown in FIGS. 1 and 2, the shuttle conveyor 10 includes an endless belt 15 running between stanchions 16 and 17. Rails 18 and 19 extend along the top of the stanchions 16 and 17 and provide a stable riding surface for the lift shuttle 11. The lift shuttle 11 is engaged to the shuttle conveyor 10 via an engagement mechanism 21.

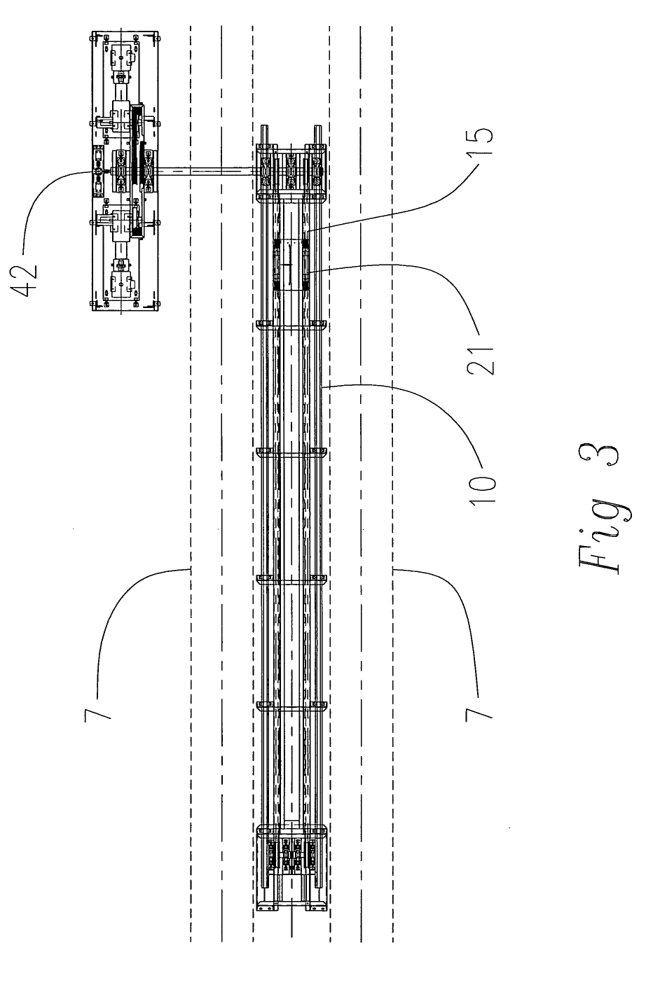

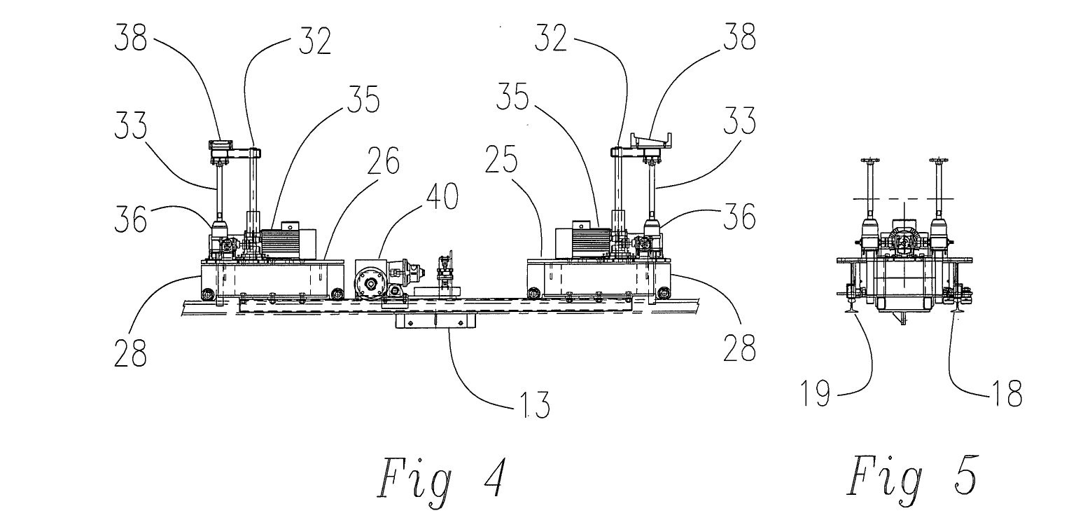

The lift shuttle 11, as shown in FIGS. 3 and 4, comprises a lifting body formed of a shuttle frame 13 and a front cart assembly 25 and a rear cart assembly 26, each cart assembly consisting of a platform 28 interconnected by the shuttle frame 13. Each platform 28 carries a jack stabilizer assembly 32 connected to pair of jacks 33 which in the illustrated example, are electrically powered screw jacks powered although fluid screw jack, or mechanical lift devices could also be used. A motor 35 and drive assembly 36 operate to cause the jacks 33 to raise in stabilization by the jack stabilizer assembly 32. Mounts 38 atop the jack 33 are designed to engage with fixtures on the underside of the vehicle 4. Positioning of the jacks 33 and lift height of the jacks are pre-selected so as to perfectly engage with fixture engagement points on the vehicle 4 and so that the vehicle is lifted and stabilized by the lift shuttle 11. Each lift shuttle 11 also carries a motor drive assembly 40 to move the shuttle 11 for maintenance purposes without moving the shuttle conveyor 10, after disengaged from the shuttle conveyor 10.

The shuttle conveyor 10 is powered by a drive assembly 42 which includes a motor, gearbox and bearings and is controlled by an electrical logic system. The logic system is timed to the first conveyor system 3 so that the lift shuttle 11 moves in precise coordination with the first conveyor system 3.

Shuttle travel speed can be changed so that the vehicle 4 is precisely delivered to the second system 7. The drive assembly 42 receives its operating impulses from a controller (not shown) which receives timing impulse from both conveyor systems and actuates the lift sequence.

In use, a vehicle 4 arrives on the overhead conveyor system 3 and arrives over the transfer and stabilizing apparatus 1. The lift shuttle 11 is timed to operate in conjunction with the overhead conveyor system 3 by the aforementioned logic means determining distance and speed of travel of vehicles on the conveyor system 3. As the vehicle approaches, the lift shuttle begins to accelerate on the shuttle conveyor 10. Electrical impulses to the motors in the front and rear cart assemblies 25 and 26 cause the jacks 33 and jack stabilizer assemblies 32 to extend to engage the vehicle 4. Once the vehicle engaged and lifted, the vehicle carrier 5 may be caused to open so that the overhead conveyor system 3 is disengaged from the vehicle 4. The shuttle conveyor 10 carries the lift shuttle with the vehicle 4 thereon a predetermined distance of the shuttle conveyor 10. Further assembly operations may be performed on the vehicle 4 and then the vehicle carrier 5 from the overhead conveyor system 3 re-engaged to carry the vehicle 4 away. Alternatively, the transfer and stabilizing apparatus is used for transfer of the vehicle 4 to a flat top conveyor system 7. The shuttle conveyor 10 carries the vehicle forward until reaching the flat top conveyor system and then the jacks 33 lower to place the vehicle on the conveyor system 7.

What is claimed and desired to be secured by Letters Patent is:

1. A transfer apparatus for removing a vehicle borne by a first vehicle assembly conveyor system, and selectively transferring the vehicle to a second conveyor system, the transfer apparatus comprising guide rails and a lift shuttle movable upon the guide rails and mounted between the first vehicle assembly conveyor system and the second conveyor system, the lift shuttle having a shuttle body with a lifting mechanism thereon for engaging the vehicle and raising the vehicle from a vehicle carrier of the first vehicle assembly conveyor system and wherein, after a predetermined distance of travel of the lift shuttle on the guide rails, the lifting mechanism lowers the vehicle to either place the vehicle upon the vehicle carrier or place the vehicle upon the second conveyor system.

2. The transfer apparatus set forth in claim 1 wherein the lifting mechanism is an electrically powered screw jack.

3. The transfer apparatus set forth in claim 1 including a drive motor and belt on said lift shuttle for movement thereof on said guide rails.

4. The transfer apparatus set forth in claim 1 wherein the lifting mechanism are lift arms.

5. The transfer apparatus set forth in claim 1 wherein the lifting mechanism is a fluid cylinder.

6. A transfer apparatus for removing a vehicle borne by an overhead or a side lift vehicle assembly conveyor system and selectively transferring the vehicle to a floor conveyor system, the transfer apparatus comprising guide rails with a lift shuttle mechanism riding on the guide rails and movable back and forth there along, the lift shuttle mechanism lifting by electrical powered vertical jacks and having a shuttle body with motor and drive mechanism for movement on the guide rails, wherein the lift shuttle mechanism lifts the vehicle off a carrier of the overhead or the side lift vehicle assembly conveyor system and then after a pre-determined distance of travel of the lift shuttle mechanism along the guide rails, the lift shuttle mechanism lowers the vehicle to either place the vehicle again on the carrier or lower the vehicle upon the floor conveyor system.
